(19) United States
(12) Patent Application Publication
(10) Pub. No.: US 2002/0077571 A1
(43) Pub. Date: Jun. 20, 2002

(54) Method of psychotherapeutic influence

(76) Inventor: Sergei Petrovich Semenov, Sankt Petersburg (RU)

Correspondence Address: HENRY M FEIEREISEN, 350 FIFTH AVENUE, SUITE 3220, NEW YORK, NY, 10118, US

(21) Appl. No.: 10/020,771

(22) Filed: Dec. 12, 2001

(30) Foreign Application Priority Data
Dec. 14, 2000 (RU) 2000130933

(51) Int. Cl. A61H 1/02

(52) U.S. Cl. 601/1

(57) ABSTRACT

The use: medicine, particularly psychotherapy, correction of psychoemotional and psychosomatic disorders. The essence: in order to consolidate the desired alterations anchoring is used, in so doing basic suggestion formulae are related by way of association to the patient's feeling of pulsation. Using patient's own feeling of pulsation as a stimulus increases the efficiency of the treatment because pulsations are always felt by patient, they intensify in frustration and, being semantically linked to suggested alterations, they can unconsciously evoke and produce new patterns of behaviour. Before inducing trance squeezing bands are applied on patient's right and left fingers and/or toes, the extent of squeezing is adjusted until the patient can feel the pulsation under the bands, in the process of suggestion before pronouncing a formula the patient's attention is drawn to the feeling of pulsation and the alteration being suggested is verbally linked to the feeling of pulsation.

### CROSS-REFERENCES TO RELATED APPLICATIONS

This application claims the priority of Russian Patent Application, Serial No. 2000130933, filed Dec. 14, 2000, the subject matter of which is incorporated herein by reference.

### BACKGROUND OF THE INVENTION

The present invention relates to the field of medicine, particularly to psychotherapy and may be used in correction of psychoemotional and psychosomatic disorders.

Nowadays the number of psychologically caused disorders has increased significantly. The accelerated tempo of modern living and complicated interpersonal communication lead to higher stress risks resulting in increased psychic disorders, alcoholism, drug addiction etc. In view of this the creation of methods of psychotherapeutic correction is actual.

The modern psychotherapeutic technology includes various methods of correction of psychosomatic disorders which contributes to a higher success rate in their treatment ( [symbol] [symbol] [symbol] M., [symbol] , 1985 [Karvasarsky B. D. Psychotherapy]; [symbol] [symbol] . [symbol] . [symbol] . [symbol] . M., [symbol] , 1990 [Bul P. Psychotherapy. Hypnosis. Suggestion]).

There is a method of psychotherapeutic influence in treating borderline cases a feature of which is the use of rational psychotherapy techniques to bring the essence of disease, the mechanisms of its development, and the ways to eliminate them home to a patient. They induce a hypnotic state in a patient and perform direct and indirect curative suggestion.

The psychotherapeutic influence plays an important role in treating patients addicted to alcohol, drugs, and other psychoactive means. Medicines and drugs addiction is a chronic disease, the morbid process involving all vital systems of a person including the motivational system. Therefore the psychotherapeutic methods allowing to influence personal attitudes and motivation are of great importance in treating such diseases.

The clinical practice also demonstrated that psychotherapy is an essential part of treatment when dealing with alcohol, tobacco and drug addicts.

A. V. Dovzhenko has developed the method of stress-psychotherapy ( [symbol] [symbol] [symbol] [symbol] [symbol] [symbol] [symbol] [symbol] . [symbol] [symbol] . M., 1984, c.7 [The stress-psychotherapy for out-patients with alcohol addiction]). The use of the techniques based on this method and treating different dependencies is growing. The known techniques include rational psychotherapy, suggestion in indirect and imperative forms, coding i.e. suggestion of a definite psychological position, and the use of a placebo. These techniques use the same general principle of A. V.Dovzhenko's method but different expedients. For example, in the technique of drug addiction treatment (patent #1601822) apomorphine is used as a placebo, in patent #2034576 “the pledge” involving religious ideas is used as a psychological position, in patent #2006220 the areas where great occipital nerve comes to the surface of the skull are additionally stimulated as reflex zones etc. The mentioned techniques are a combination of expedients new in form but known in essence that allow to exert psychological influence on different levels of the hierarchical system of personal attitudes.

There is a method of psychotherapeutic influence involving two consecutive steps. At the first step they perform rational psychotherapy, bringing the necessity of treatment home to patient and reinforcing his/her motivation. At the second step they perform conditional reflex therapy, which involves suggestion in hypnotic or normal state and, against this background, reflex conditioning wherein anomalous behaviour is suppressed through “punishment” and/or the right behaviour is reinforced through “encouragement”. The performed psychotherapy is directed towards formation of new positive skills and renunciation of pathological patterns of behaviour. For example, when treating alcoholism emetics are used to cause unpleasant or painful sensations in patients; when treating neurotic or borderline cases they use a system of encouragement (in the form of praise, reward) and punishment (in the form of criticism or electric jolt) ( [symbol] [symbol] [symbol] . M., [symbol] , 1985, ctp.111-123 [Karvasarsky B. D. Psychotherapy]).

However, the symbolic essence of “rewards” and “punishments” is often transparent to patient which impairs the efficiency of the treatment. In addition, a patient may consciously or unconsciously block the generation of conditioned reflexes needed for recovery.

The most similar method of psychotherapy is the one that involves rational psychotherapy intended to enhance patient's motivation and confidence in the possibility of recovery, the techniques of Neuro-Linguistic Programming inducing mild hypnotic trance, suggestion of specially prepared text divided into five parts, and pronouncing a suggestive formula after each of the parts. When reading the text of suggestion the timbre, rhythm, volume, emotionality, and imperativeness of doctor's voice keep changing. In the process of treatment the technique of anchoring is used. At the end of the session amnesia is produced (patent #2033817,1985). This method has considerable potentialities, however, insufficient impact on patient's subconsciousness results in only short-term effect.

It would therefore be desirable and advantageous to provide an improved method of psychotherapy to obviate prior art shortcomings.

### SUMMARY OF THE INVENTION

Applying an anchor, i.e. enabling a stimulus to cause the whole suggested alteration, is essential for consolidating the performed suggestion. To make the anchor work the stimulus must be reproduced precisely.

To enhance the efficiency of the treatment one can use as a stimulus patient's own pulse and sensations. Such a kinaesthetic stimulus associated with basic suggestion formulae is most adequate to produce the desired effect.

So the essence of the novel and inventive method is, to consolidate the desired alterations basic suggestion formulae are related by way of association to the patient's feeling of pulsation. To ensure distinct kinaesthetic sensations elastic squeezing bands are applied on the patient's fingers or toes in the course of psychotherapeutic session.

Using patient's own feeling of pulsation as a stimulus increases the efficiency of the treatment because pulsations are always felt by patient, they intensify in frustration and, being semantically linked to suggested alterations, they can unconsciously evoke and produce new patterns of behaviour.

### DETAILED DESCRIPTION

Features and advantages of the present invention will be more readily apparent upon reading of the following description.

The method according to the present invention is performed as follows: During the first meeting with a patient they determine his/her disease (disorder), analyse his/her complaints, anamnesis and psychological traits of his/her personality, they reveal factors contributing to the disease, the range of circumstances having provoked the disorder. When dealing with dependencies they reveal factors provoking alcohol, drug or medicines consumption. Using the obtained information as the base a doctor prepares the text of suggestion and formulae having regard to the patient's intellectual level, his/her impressionability and suggestibility, the level of religiosity as well as the stage of the disease. The text and the formulae of suggestion are compiled with regard to the corresponding requirements ( [symbol] [symbol] [symbol] . [symbol] . [symbol] . [symbol] , [symbol] , 1982, cTp.48-97 [Slobodnyak A. P. Psychotherapy. Suggestion. Hypnosis]).

At the step of rational psychotherapy they bring the causes of the disease home to the patient, stimulate his/her motivation to recover, convince the patient in the possibility of recovery and strengthen this by suggestion of a high efficiency of the method.

They explain the essence of the method and the features of hypnotism to the patient, inform him/her that specific sensations will be produced and that the formula of suggestion includes the information about needed alterations.

When the patient is properly convinced, they apply elastic squeezing bands on his/her fingers and/or toes that ensure the feeling of pulsation under them.

It has been empirically determined that dealing with alcoholism the best effect is achieved when the band is applied on the end or middle phalanx of patient's thumb or at the bottom of patient's fourth finger, as well as on patient's fourth toe. When dealing with obesity the best result is produced when the band is applied on the end phalanx of patient's thumb, on the end and middle phalanges of patient's index finger, on the end and middle phalanges of patient's little finger, and on the end phalanx of patient's big toe.

Next, the state of mild trance is induced after which a “convincing” information is presented to the patient, e.g. “you feel your arm lying on the soft arm of the chair”, “you feel your feet touch the floor”, “you can distinctly feel the pulsations under the band”. Following 5-6 correctly described sensations they begin imperative suggestion of the prepared text. Pronouncing the text they gradually change the timbre, volume, rhythm and emotionality of the voice which aids to pass over the mechanisms of censorship of auditory system resulting in that the patient trusts this information ( [symbol] A.M. [symbol] M., [symbol] , 1993, cTp.148-153 [Svyadoshch A. M. Neuroses]).

After every part of the text they repeat the formulae of suggestion so that each formula repeats 6-7 times over the session. In so doing the basic formulae involving the desired alterations (behavioural, functional etc.) are related by way of association to the feeling of pulsation under the elastic band, i.e. an anchor is applied which means that one element (physiological in this case) is enabled to evoke the experience as a whole. This permits the suggested unconscious psychological position to be evoked when needed (in frustration, anxiety, decision making). To this end, before pronouncing a suggestive formula the patient's attention is drawn to the pulsations under the bands in such a way that he/she can synchronously feel the pulsations in his/her hands and feet: “Attention, feel the pulsation . . . Concentrate on the pulsation . . . Your sensations grow distinct . . . It is enough that you feel the pulsation to make anxiety vanish into thin air . . . Hurt passes off and the world seems so beautiful . . . Just feel your heart beating and nervous strain passes off . . . ”

Having finished the suggestion of curative program, amnesia is produced. To this end, they cease hypnotic trance with the help of awakening formulae and immediately draw the patient's attention to an incidental object. The use of amnesia producing techniques also allows the therapeutic information to stay out of the censorship of consciousness.

After the session, the patient is recommended to repeat the treatment in case troublesome symptoms should appear again.

### EXAMPLES

A patient S., 32 years old, a hotel manager.

The diagnosis: chronic alcoholism of the second stage against the background of residual organic brain damage (posttraumatic encephalopathy).

From anamnesis: no hereditary diseases, brought up in a non-full family, left to his own devices most of the time, started to drink at the age of 16. Being a student he went in for sport, was 3 times hospitalised with concussion of the brain of different degree. In the last two years the signs of alcohol dependence aggravated: he lost control of the dose of alcohol. Fits of drinking began to occur, he began to drink in the morning. When deprived of alcohol he feels himself bad: there is weakness, sweating, hand tremor, anxiety, depression, and insomnia.

Analysis of anamnesis revealed the factors destabilizing the patient's condition and provoking alcohol consumption, namely social dependence on the rituals of necessarily and heavily drinking combined with ambition to succeed.

In the course of rational psychotherapy, in accordance with the first part of the text, realization by patient of his dependence on alcohol and of all possible consequences of the disease was achieved. The motivation to recover was formed basing on the idea of malignity of alcohol addiction, hindrances in self-actualisation and social growth. Through logically constructed explanations and convincing arguments a correct attitude towards the disease was formed, through direct proofs and indirect suggestion the possibility to recover was demonstrated, as well as the necessity to alter behaviour with this aim.

After that a mild hypnotic trance was induced in the patient.

The second part of the text had been compiled so as to alienate the disease from the patient. Alcoholism was presented as something that does not correspond to the patient's personality, his aims and values.

The third part of the text contained the information directed towards the instinct of self-preservation, i.e. possible consequences of the disease were emotionally stressed.

The fourth part of the text contained positive reinforcement and conviction that the treatment succeeds.

The fifth part was addressed to the patient's personality and described a model of new self-perception.

Before inducing a hypnotic trance the squeezing bands in the form of elastic bandage No. 1 were applied on the end and middle phalanges of the patient's both thumbs. The extent of squeezing was adjusted so that the feeling of pulsation arose.

After every part of the text, the patient's attention was drawn to the pulsation under the bands and these feelings were verbally linked to the key suggestive formulae.

For example: “Attention, feel the pulsation . . . Concentrate on the pulsation, you are getting free from trouble, doubts and anxiety”; “You are feeling the pulsation in your right and left hand at the same time; they grow clear, distinct; aversion to the sight and smell of alcohol is growing in you . . . From now on alcohol is nothing to you”; “You feel distinct pulsation under the bands on your thumbs, from now on you can easily deny yourself alcohol, you can easily refuse the offer to drink”.

Amnesia was suggested and the patient was awakened out of the trance.

After a week the second session was performed.

Monitoring the patient during one year showed complete remission of alcoholism as well as good social and psychological adaptation.

Nine patients were treated with the help of the described method and in all cases it had a good therapeutic effect.

While the invention has been illustrated and described as embodied in a method of psychotherapeutic influence, it is not intended to be limited to the details shown since various modifications and structural changes may be made without departing in any way from the spirit of the present invention.

What is claimed as new and desired to be protected by Letters Patent is set forth in the appended claims:

What is claimed is:

1. A method of psychotherapeutic influence which includes the techniques of rational psychotherapy, Neuro-Linguistic Programming, trance inducing, suggestion as well as verbally linking suggestion formulae to a physiological process, characterized in that the heart rhythm is used as a physiological process, before inducing trance squeezing bands are applied on patient's right and left fingers and/or toes, the extent of squeezing is adjusted until the patient can feel the pulsation under the bands, in the process of suggestion before pronouncing a formula the patient's attention is drawn to the feeling of pulsation and the alteration being suggested is verbally linked to the feeling of pulsation.

2. The method of claim 1, wherein in alcoholism treatment elastic squeezing bands are applied on the end and middle phalanges of patient's thumbs or/and at the bottom of patient's fourth fingers.

3. The method of claim 2, wherein elastic bands are applied on patient's fourth toes.

4. The method of claim 1, wherein in obesity treatment elastic squeezing bands are applied on the end phalanges of patient's thumbs or on the end and middle phalanges of patient's index fingers, and on the end and middle phalanges of patient's little fingers.

5. The method of claim 4, wherein the bands are applied on the end phalanges of patient's big toes.

6. The method of claim 1, wherein the squeezing band is made with the help of elastic bandage No 1.
